(19) United States
(12) Patent Application Publication
(10) Pub. No.: US 2022/0004631 A1
(43) Pub. Date: Jan. 6, 2022

(54) DISCRIMINATION APPARATUS, DISCRIMINATION METHOD AND LEARNING APPARATUS

(71) Applicants: Akira Otsuka, Kawasaki-shi (JP); Technical Infrastructure Logic Corporation, Tokyo (JP)

(72) Inventors: Akira Otsuka, Kawasaki-shi (JP); Yuhei Otsubo, Yokohama-shi (JP)

(21) Appl. No.: 17/376,009

(22) Filed: Jul. 14, 2021

Related U.S. Application Data
(63) Continuation of application No. PCT/JP2019/000965, filed on Jan. 15, 2019.

(51) Int. Cl. G06F 21/56; G06N 3/04

(52) U.S. Cl. CPC G06F 21/56; G06F 2221/034; G06N 3/04

(57) ABSTRACT

According to the present embodiment, a discrimination apparatus includes a processor. The processor extracts a plurality of instructions from binary data. The processor generates a plurality of input data strings by padding with a fixed character on data strings of the instructions so that the data strings of the instructions each have a fixed length. The processor generates a feature vector of a program including the instructions or a classification result related to the program by using the input data strings and a trained convolutional neural network including a convolution layer that performs processing in units of the instructions.

### CROSS-REFERENCE TO RELATED APPLICATIONS

This application is a Continuation Application of PCT Application No. PCT/JP2019/000965, filed Jan. 15, 2019, the entire contents of all of which are incorporated herein by reference.

### FIELD

The present embodiment relates generally to a discrimination apparatus, a discrimination method, and a learning apparatus.

### BACKGROUND

It is said that hundreds of thousands of new types of malware appear per day, and there is an urgent need to automatically analyze and classify malware from the viewpoint of security enhancement. As a malware detection method, for example, there is a method of detecting a return oriented programming (RoP) attack code by utilizing the fact that the distribution of attack code values is within a certain range (see, for example, Patent Literature 1). In addition, there is a method of actually executing a program that processes a document file and determining whether or not the value of the program counter falls within a certain range, thereby detecting whether or not the processing program includes malware that intentionally changes a control flow of the processing program (see, for example, Patent Literature 2).

### CITATION LIST

### Patent Literature

[PTL 1] Jpn. Pat. Appln. KOKAI Publication No. 2016-9405

[PTL 2] Japanese Patent No. 5265061

### SUMMARY

However, the technique disclosed in Patent Literature 1 has a problem wherein features that can be identified by the identifier are limited to those that can be linearly separated. The technique disclosed in Patent Literature 2 has a problem wherein the technique requires time and effort because a check code needs to be additionally embedded in a processing program of a document file to be analyzed.

The present application has been made in view of the above-described circumstances, and an object thereof is to provide a discrimination apparatus, an identification program, and a learning apparatus which are capable of identifying a target program in detail with high accuracy.

### BRIEF DESCRIPTION OF THE DRAWINGS

FIG. 1 is a block diagram showing a discrimination apparatus according to the present embodiment.

FIG. 2 is a flowchart showing an operation example of the discrimination apparatus.

FIG. 3 is a diagram showing a specific example of input data conversion processing.

FIG. 4 is a diagram showing a configuration example of a trained convolutional neural network (CNN).

FIG. 5 is a diagram showing a display example of a classification result of the discrimination apparatus.

FIG. 6 is a diagram showing a display example of a classification result of the discrimination apparatus.

FIG. 7 is a block diagram showing a learning apparatus.

### DETAILED DESCRIPTION

According to the present embodiment, a discrimination apparatus includes a processor. The processor extracts a plurality of instructions from binary data. The processor generates a plurality of input data strings by padding with a fixed character on data strings of the instructions so that the data strings of the instructions each have a fixed length. The processor generates a feature vector of a program including the instructions or a classification result related to the program by using the input data strings and a trained convolutional neural network including a convolution layer that performs processing in units of the instructions.

Hereinafter, a discrimination apparatus, a discrimination method, and a learning apparatus according to an embodiment of the present invention will be described in detail with reference to the accompanying drawings. In the following embodiment, portions denoted by the same reference numeral perform the same operation, and redundant descriptions will be omitted.

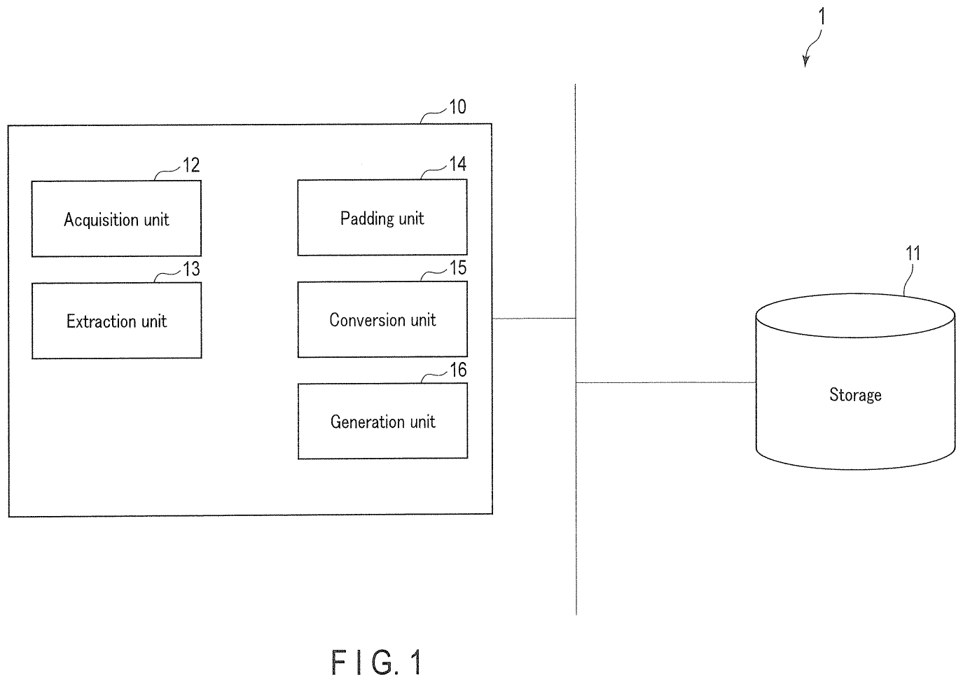

A discrimination apparatus 1 according to the present embodiment includes a storage 11, an acquisition unit 12, an extraction unit 13, a padding unit 14, a conversion unit 15, and a generation unit 16. FIG. 1 shows an example in which the acquisition unit 12, the extraction unit 13, the padding unit 14, the conversion unit 15, and the generation unit 16 are implemented in electronic circuitry 10. The electronic circuitry 10 is configured by a single processing circuit, e.g., such as a central processing unit (CPU) or a graphics processing unit (GPU), or an integrated circuit such as an application specific integrated circuit (ASIC) or a field programmable gate array (FPGA). The electronic circuitry 10 and the storage 11 are connected to each other via a bus in such a manner that data can be transmitted and received therebetween. The configuration is not limited to this, and each unit may be configured as a single processing circuit or a single integrated circuit.

The storage 11 stores binary data of a file to be processed (hereinafter, referred to as a target file) and a trained convolutional neural network (CNN) model (hereinafter referred to as a trained CNN). The storage 11 is configured by a storage device, e.g., such as a read only memory (ROM), a random access memory (RAM), a hard disk drive (HDD), a solid state drive (SSD), or an integrated circuit storage device.

In the present embodiment, as the target file, a document file (such as a Word® file) in which a program (shell code) is embedded is assumed; however, other types of files, such as an execution file, a portable document format (PDF) file, an image file, and an audio file, in which a program is embedded, can also be processed in a similar manner. The storage 11 may store the target file in the original file format, instead of the binary data format.

As the trained CNN, a forward-propagation convolutional neural network is assumed; however, special multilayer CNNs such as so-called ResNet and DenseNet, which are different from common CNNs, are also applicable in a similar manner. Here, a convolution layer included in the trained CNN is designed to perform processing in units of instructions of a program. A training method and utilization method of the trained CNN according to the present embodiment will be described later.

The acquisition unit 12 acquires binary data of the target file from the storage 11. When the target file is not stored in the binary data format in the storage 11, the acquisition unit 12 may acquire the target file, and the acquisition unit 12 or a binary conversion unit (not shown) may generate binary data of the target file by performing common binary conversion processing on the target file. The acquisition unit 12 may externally acquire the target file or binary data of the target file.

The extraction unit 13 regards the binary data as a set of instructions and extracts data strings of instructions, each including an operand. As a method of extracting one instruction, a data string of one instruction may be extracted by, for example, executing disassembler processing. Any method may be used as long as a data string of one instruction can be extracted. The “instruction” according to the present embodiment is a concept including an opcode, which means an operator, and an operand, which means an object of an operation. Whether or not the binary data is actually a set of instructions does not matter.

The padding unit 14 performs padding with a fixed character on the data strings of instructions so that the data string of each instruction has a fixed length, and thereby generates a plurality of input data strings.

The conversion unit 15 generates a plurality of input layer data strings by executing bit encoding processing on the input data strings.

The generation unit 16 generates a feature vector or a classification result of the program based on the input data strings or input layer data strings by using the trained CNN. As the classification result, a result of at least one of classification between programs and non-programs, classification by type of compiler used for generating the program, classification by type of program conversion tool (such as an obfuscator, a packer, and the like) used for generating the program, and classification by type of function included in the program is assumed.

The identification 1 according to the present embodiment is assumed to be utilized for, for example, detection of malware embedded in a document file and detection of detailed information on a program of the malware, such as a type of compiler used when the program of the malware is generated; however, the utilization example is not limited to this, and identification can be performed on any program and detailed information on the program can be obtained.

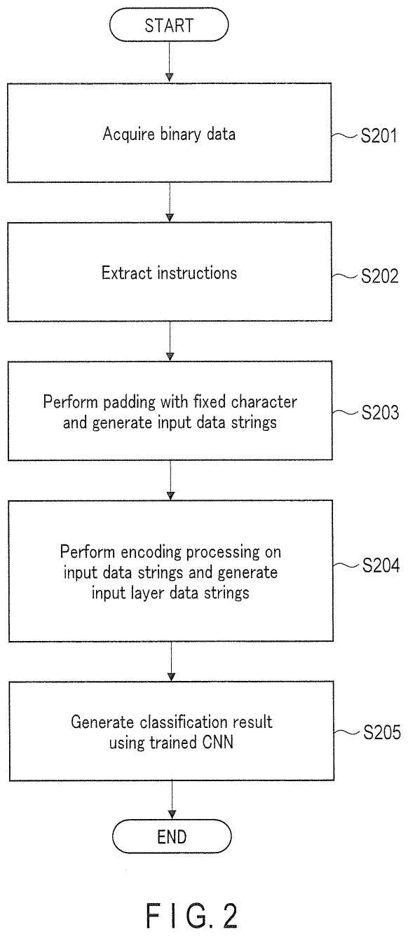

Next, an operation example of the discrimination apparatus 1 according to the present embodiment will be described with reference to the flowchart of FIG. 2.

In step S201, the acquisition unit 12 acquires binary data of a target file.

In step S202, the extraction unit 13 regards the acquired binary data as a set of instructions, and divides the binary data into individual instructions to extract a plurality of instructions. Regarding extraction of each instruction, when there is an operand for an opcode, a set of the opcode and operand is extracted as an instruction. Here, the number of instructions to be extracted is assumed to be 16 or more. The number of instructions may be less than 16 as long as classification can be performed in the training and designing process of the CNN. The extraction unit 13 may search the binary data from the head until 16 instructions are extracted from the binary data.

In step S203, the padding unit 14 performs padding with a fixed character on data strings of the extracted instructions so that the data string of each instruction has a fixed length, and thereby generates a plurality of input data strings. The fixed length may be set to be longer than or equal to the maximum instruction length of the architecture. Here, 128 bits (16 bytes) are assumed as the fixed length, and zero padding is performed so that each instruction becomes a 128-bit data string. However, the fixed length may be changed according to the maximum instruction length of the architecture to be used. The fixed character is not limited to “0” (zero), and may be any character, such as “F”, as long as it can be recognized as a pad character.

In general, since the data length (bit length) varies depending on the type of instruction, it is difficult to perform processing in units of instructions if instructions are input to the CNN as they are. According to the processing of step S203 described above, the instructions are provided with a fixed length; therefore, processing can be performed for each instruction in the CNN.

In step S204, the conversion unit 15 executes one or more encoding processes for each of the input data strings generated in step S203 to generate input layer data strings obtained by converting the input data strings. Specifically, the conversion unit 15 performs a plurality of encoding processes from the first encoding process to the third encoding process on each 128-bit input data string to obtain an input layer data string of a fixed length corresponding to 1024 input layer neurons. One element of the input layer data string may be a floating point number or a bit of a binary number (one of two values, 0 and 1). The fixed length is not limited to 1024 and may be set to any value.

The encoding processes include, for example, a single-bit process of converting an input data string into an input layer data string which expresses the input data string with one “1” bit and a plurality of “0” bits (also referred to as a first encoding process), a process of directly letting a bit sequence corresponding to the input data string be an input layer data string without change (also referred to as a second encoding process), and a process of converting a numerical value expressed by the input data string into a single input layer data item which is a scalar value (also referred to as a third encoding process).

The first encoding process will be specifically described. First, an input data string representing one instruction is divided into 8-bit units from the head and then each 8-bit bit string is expressed by a 256-bit bit string. That is, eight bits can express 256 values from “0(00000000₍₂₎)” to “255(11111111₍₂₎)”. A value is expressed by counting a 256-bit bit string from the head to set a bit at a position matching a value to be expressed (change the bit to “1”) and leaving the other bits “0”. That is, when the conversion unit 15 applies the first encoding process to an input data string “00000001₍₂₎”, an input layer data string “01000 . . . 0”, which is a 256-bit bit string in which the second bit from the head is set and the other bits remain “0”, can be obtained.

The second encoding process is a process for arranging the bit sequence of an input data string as an input layer data string without change. The second encoding process includes a process such as a conversion from a decimal number to a binary number.

An application example of the third encoding process will be described. For example, assuming a machine language word “JMP 008A” which indicates a movement to an address, a difference of one bit in the value of an address given as an operand may not affect the processing of the instruction. In this case, a bit sequence representing an operand of the input data string may be converted into a scalar value in a range between 0 and 1. That is, a bit sequence representing an operand, here, a value expressed by 16 bits, may be expressed by a floating point number or the like. As a result, the operand is expressed by a scalar value; therefore, even if the value of a low-order bit of the operand is different, the difference is not emphasized in the encoding process.

For example, an input layer data string may be generated by combining encoded data such that a 128-bit data string obtained by performing the second encoding process on an input data string serves as the first to 128th bit of the input layer data string, a 256-bit data string obtained by performing the first encoding process on the first 8 bits of the input data string serves as the 129th to 384th bits of the input layer data string, and a scalar value obtained by performing the third encoding process on the operand portion of the input data string serves as the 385th bit of the input layer data string.

In step S205, the generation unit 16 inputs the input layer data strings to the trained CNN and generates a classification result, which is an output of the trained CNN. In a convolution layer of the trained CNN, processing may be performed in units of instructions. For example, in a convolution layer to which input layer data strings are input, processing may be performed in units of the data length of the input layer data strings. The generation unit 16 may output a feature vector of a program related to a plurality of instructions as an output of the trained CNN. When a feature vector is output, the generation unit 16 may input a plurality of input layer data strings to a trained CNN that converts an output of a convolution layer into a one-dimensional vector and outputs the one-dimensional vector.

The input data strings may be directly input to the trained CNN without being subjected to the encoding processing in step S204. Further, an encoding process to be applied may be determined from among the first encoding process to the third encoding process in step S204 in accordance with the type of instruction or the type of operand.

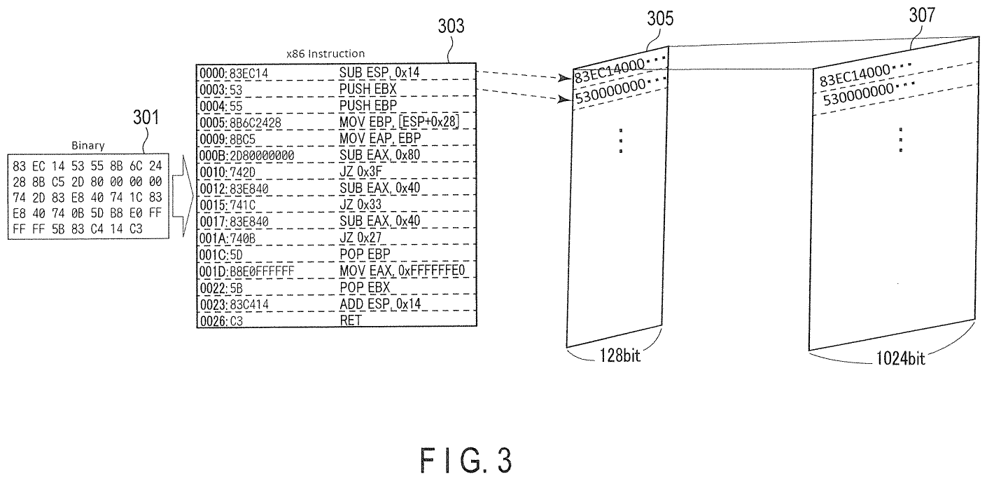

Next, a specific example of the processing from step S202 to step S204, i.e., input data conversion processing, will be described with reference to FIG. 3.

A plurality of instructions are extracted from binary data 301 to be processed by the processing of step S202. The extraction result is shown in an instruction set table 303. In FIG. 3, the instruction set table 303 shows x86 instruction set, the instruction set is not limited to this, and any instruction set of other architecture may be used. Specifically, the binary data 301 is searched, and extracted instructions are sequentially accumulated, such as an instruction data string “83EC14” (“SUB ESP, 0x14” in assembler language) and instruction data string “53” (“PUSH EBX” in assembler language). Here, instructions are extracted until the number of instructions reaches 16.

By the processing of step S203, zero padding is performed so that the data string of each of the extracted instructions has a fixed length of 128 bits, and a plurality of input data strings 305 are generated.

By the processing of step S204, a 128-bit input data string 305 per instruction is encoded, and a plurality of input layer data strings 307 are generated in which the 128-bit length is increased to a fixed length corresponding to 1024 input layer neurons.

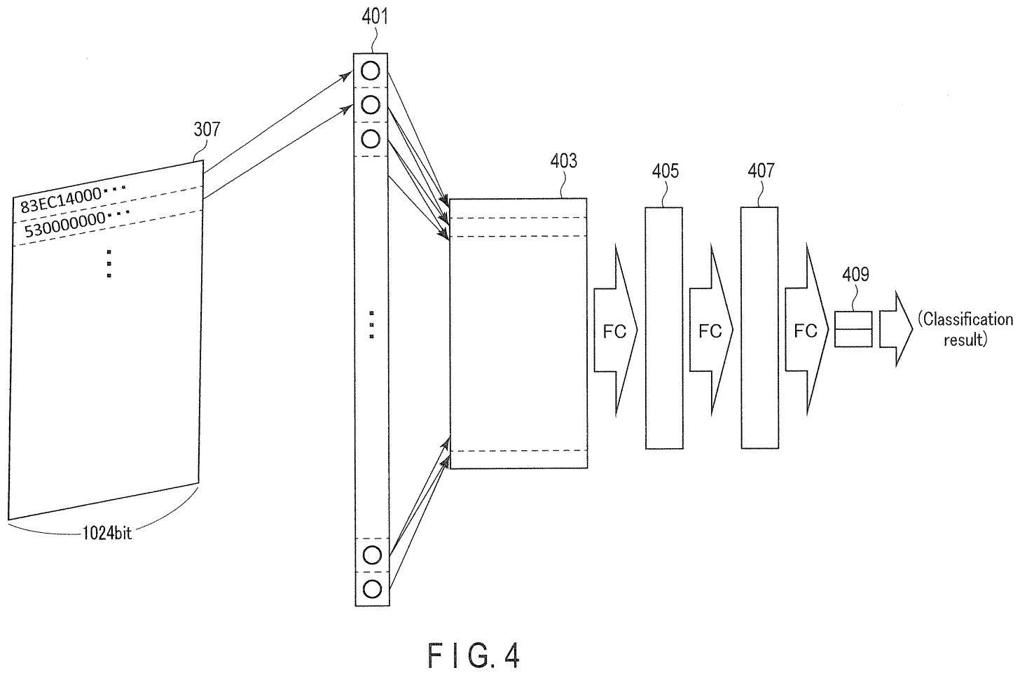

Next, a configuration example of the trained CNN used in the processing of step S205 will be described with reference to FIG. 4.

The CNN according to the present embodiment includes a first convolution layer 401, a second convolution layer 403, a first fully connection layer 405, a second fully connection layer 407, and a third fully connection layer 409, which is an output layer.

Here, in the first convolution layer 401 to which a plurality of input layer data strings 307 are input, the convolution filter size used for the input layer data strings and the stride value indicating the width by which the filter is moved are determined so that processing is performed for each input layer data string, that is, for each instruction. Specifically, the convolution filter size is set to “1024” and the stride is set to “1024” so as to be equal to the above-described fixed length of the input layer data string. As a result, convolution processing can be executed for each instruction, and a local receptive field specialized for recognition of a fixed-length instruction can be formed. The number of channels of the first convolution layer 401 is 64 or 96; however, the number is not limited to this, and any number of channels may be set.

In the second convolution layer 403, the output of the first convolution layer 401 is input. In the second convolution layer 403, the convolution filter size and stride are determined so that a feature of the relationship between two instructions can be obtained. Here, the convolution filter size is set to 2, the stride is set to 1, and the number of channels is set to 256; however, the numbers are not limited to these, and the convolution filter size and stride may be determined so that processing is performed across two instructions.

In the first fully connection layer 405 and the second fully connection layer 407, common fully connected processing is performed, and a detailed description thereof is omitted herein.

The third fully connection layer 409, which is an output layer, employs a Softmax function as an activation function and outputs a classification result as an output from the trained CNN.

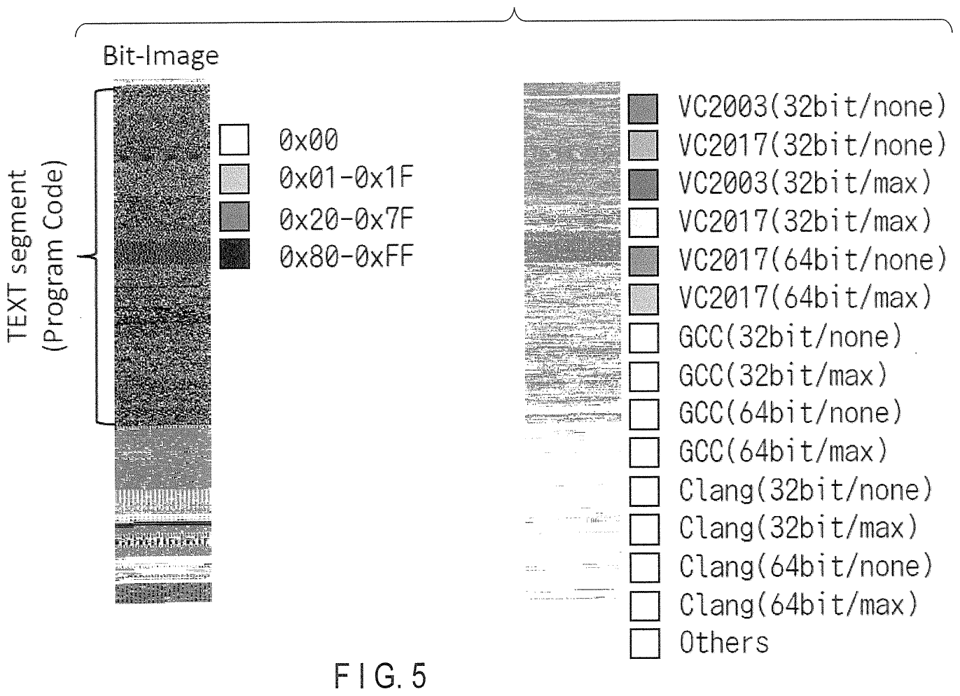

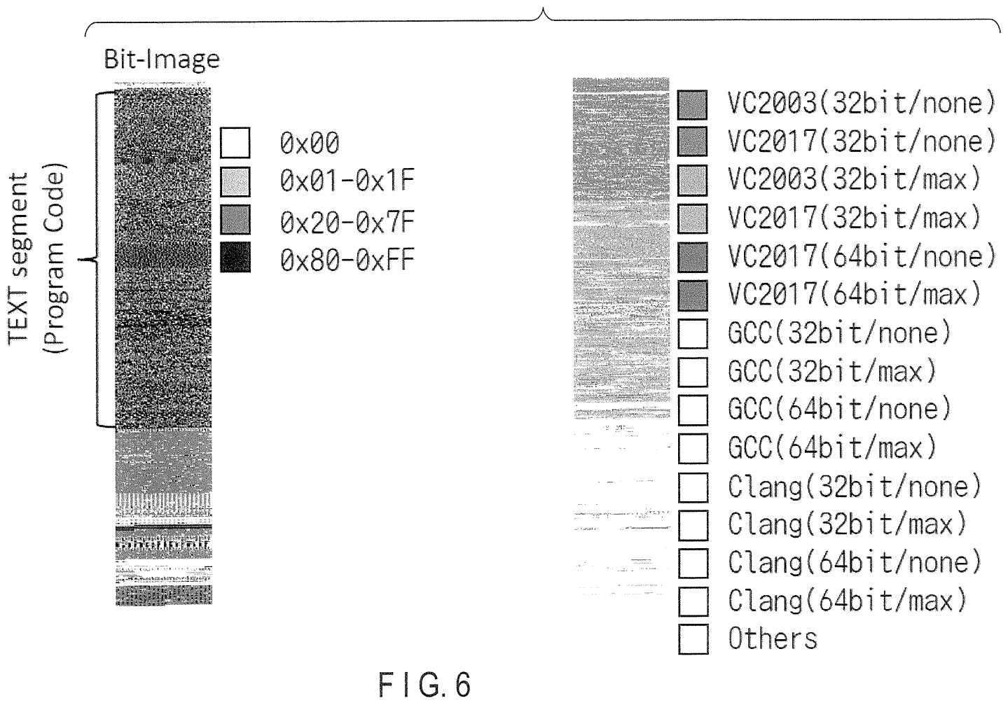

Next, a display example of the classification result of the discrimination apparatus 1 according to the present embodiment will be described with reference to FIGS. 5 and 6.

FIG. 5 is a diagram visualizing binary data as a bit image. The left part of FIG. 5 shows a bit image of binary data of a target file. Although a program is written in the first half of the binary data in the target file, it is difficult to ascertain that the program is written through visual observation.

The right part of FIG. 5 shows an output result of the discrimination apparatus 1 according to the present embodiment, in which the results of classification by compiler type of the program are color-coded and reflected in the corresponding portions of the binary data of the target file. As shown in the right part of the figure, it is possible to ascertain at a glance which position of the binary data the program is written in. Further, it is possible to easily ascertain which code processed by which compiler exists in which position of the binary data.

FIG. 6 shows the data shown in FIG. 5, in which the binary data is color-coded depending on whether or not optimization was performed at the time of compiling the program.

As shown in the right part of FIG. 6, detailed information as to whether or not optimization was performed at the time of compilation can also be easily ascertained from the bit image.

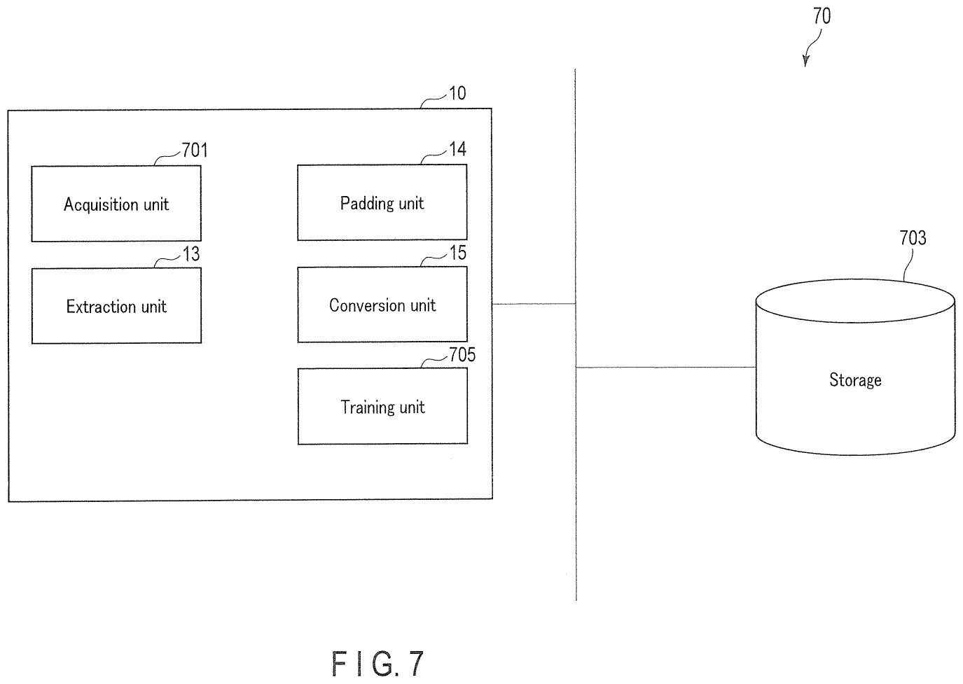

Next, a learning apparatus that trains the CNN used in the present embodiment will be described with reference to FIG. 7.

The learning apparatus 70 includes an acquisition unit 701, a storage 703, an extraction unit 13, a padding unit 14, a conversion unit 15, and a training unit 705.

The acquisition unit 701 acquires training data externally, or from the storage 703 when the training data is stored in the storage 703. The training data is a set of input data and correct answer data (output data), and is prepared according to the classification result desired to be obtained as an output of the CNN. For example, for classification by compiler type of malware, training data including, as input data, a binary data string of a non-program such as a document file or an image file and a binary data string of a common execution code (program) and including, as correct answer data, a compiler type (such as Visual C++®, GCC, or Clang) of the common execution code may be used.

The classification result may be a result of binary classification of whether or not the data is a program code. Alternatively, the classification result may be a type (packer, encryption tool, or the like) of program conversion tool used to generate the program code. Alternatively, the classification result may be a type (such as processing of “print” in the source code) of function included in the program code.

At the time of training, training with not only programs of malware, but also compiler types based on common programs, can sufficiently improve the identification sensitivity to programs. Furthermore, in the case of common programs, it is easy to prepare a large amount of data, and training efficiency can be improved.

The storage 703 stores a pre-trained CNN. The storage 703 may store training data in advance.

The binary data string of input data may be generated by the extraction unit 13, the padding unit 14, and the conversion unit 15 processing the input data in a similar manner to the above-described target data processed at the discrimination apparatus 1.

The training unit 705 may train the CNN with training data to output correct answer data in response to an input of input data, and determine parameters in the CNN by a propagation method or the like. Here, the training unit 705 may train the CNN to perform processing in units of instructions in at least one convolution layer. That is, in the first convolution layer 401 shown in FIG. 4, the convolution filter size and stride may be set so that convolution processing is performed for each instruction. Specifically, the convolution filter size and stride may be set so that, when input layer data strings are input, processing is performed in units of the data length of the input data strings in the convolution layer to which the input layer data strings are input. In the second convolution layer 403, the convolution filter size and stride may be set so that convolution processing is performed across two instructions.

The CNN trained as described above is stored in the discrimination apparatus 1, and processing on a binary data string is executed.

In the discrimination apparatus 1 according to the present embodiment, it is possible to, for example, fix the weights (parameters) in the CNN trained for classification by type of compiler, and use the trained CNN for classification other than the classification of type of compiler, such as classification of type of program conversion tool.

Specifically, the first convolution layer 401 and second convolution layer 403 included in the CNN trained for classification of type of complier are included, with their weights fixed, in a pre-trained CNN as a part thereof. The learning apparatus may calculate values (feature vector values) output from the first convolution layer 401 and the second convolution layer 403 with the weights fixed, and cause the layers (such as a pooling layer, a fully connection layer, and an output layer) subsequent to the second convolution layer 403 to train weights with training data including truth data regarding types of obfuscating tools and packers so that classification by type of obfuscating tool or packer can be performed. This process is also referred to as a Transfer Learning.

Since it is important to perform convolution processing for each instruction in a convolution layer for classification of program codes, the method of classification may be oriented to classification by compiler type or classification by program conversion tool type by the layer configuration after the convolution layer. Therefore, use of the first convolution layer 401 and the second convolution layer 403 included in a trained CNN for a pre-trained CNN enables application of the knowledge obtained by training a CNN with training data related to classification by compiler type, for which it is relatively easy to prepare a large amount of training data, to classification of classes for which it is difficult to prepare a large amount of training data.

According to the present embodiment described above, a CNN is trained by a learning apparatus to perform processing of a program of a target file in units of instructions, and a target file is classified by an discrimination apparatus including the trained CNN. Accordingly, with respect to a program (shell code) included in a document file infected with unknown malware for example, it is possible to detect the program, specify an infection position in the document file, and identify a development environment such as a compiler type or a program conversion tool used when creating a program code with high accuracy and in detail.

As described above, since the instruction according to the present embodiment includes an opcode and an operand, the CNN executes convolution processing in units of instructions each including an operand. Compiler-specific information, such as how the register is used, is reflected in the operand. Therefore, by using not only the opcode but also the operand, the CNN according to the present embodiment can identify a compiler type or the like in detail with higher accuracy.

The instructions processed in the processing procedure described in the above embodiment can be executed based on a program which is software. An advantageous effect similar to the above-described advantageous effect achieved by the discrimination apparatus can be achieved by a general-purpose computer system storing the program in a recording medium in advance and reading the stored program. Moreover, the storage medium according to the present embodiment is not limited to a medium independent from a computer or a built-in system, and includes a storage medium storing or temporarily storing a program downloaded through a local area network (LAN), the Internet, etc.

The present invention is not limited to the above-described embodiment, and can be modified in practice, without departing from the gist of the invention. In addition, embodiments may be combined as appropriate where possible, in which case a combined advantage can be attained. Furthermore, the above-described embodiment includes various stages of the invention, and various inventions can be extracted by suitably combining the structural elements disclosed herein.

1. A discrimination apparatus comprising a processor configured to:
extract a plurality of instructions from binary data;
generate a plurality of input data strings by padding with a fixed character on data strings of the instructions so that the data strings of the instructions each have a fixed length; and
generate a feature vector of a program including the instructions or a classification result related to the program by using the input data strings and a trained convolutional neural network including a convolution layer that performs processing in units of the instructions.

2. The discrimination apparatus according to claim 1, wherein the processor is further configured to:
convert the input data strings into input layer data strings by performing at least one of a first encoding process, a second encoding process and a third encoding process to the input data strings, the first encoding process converting an input data string into an input layer data string which expresses the input data string with one 1-bit and a plurality of 0-bits, the second encoding process letting a bit sequence corresponding to an input data string be an input layer data string, the third encoding process converting a numerical value expressed by an input data string into an input layer data string which is a scalar value; and
generate the feature vector or the classification result by inputting the input layer data strings to the convolutional neural network.

3. The discrimination apparatus according to claim 1, wherein a convolution filter size and stride in the convolution layer are determined so that processing is performed in units of the instructions.

4. The discrimination apparatus according to claim 1, wherein the classification result indicates a classification result of at least one of classification between a program and a non-program, classification by type of compiler used for generating the program, classification by type of program conversion tool used for generating the program, and classification by type of function included in the program.

5. The discrimination apparatus according to claim 1, wherein the processor performs disassembler processing.

6. The discrimination apparatus according to claim 1, wherein the program is malware embedded in a target file.

7. A discrimination method comprising:
extracting a plurality of instructions from binary data;
generating a plurality of input data strings by padding with a fixed character on data strings of the instructions so that the data strings of the instructions each have a fixed length; and
generating a feature vector of a program including the instructions or a classification result related to the program by using the input data strings and a trained convolutional neural network including a convolution layer that performs processing in units of the instructions.

8. The discrimination method according to claim 7, further comprising:
converting the input data strings into input layer data strings by performing at least one of a first encoding process, a second encoding process and a third encoding process to the input data strings, the first encoding process converting an input data string into an input layer data string which expresses the input data string with one 1-bit and a plurality of 0-bits, the second encoding process letting a bit sequence corresponding to an input data string be an input layer data string, the third encoding process converting a numerical value expressed by an input data string into an input layer data string which is a scalar value; and
generating the feature vector or the classification result by inputting the input layer data strings to the convolutional neural network.

9. The discrimination method according to claim 7, wherein a convolution filter size and stride in the convolution layer are determined so that processing is performed in units of the instructions.

10. The discrimination method according to claim 7, wherein the classification result indicates a classification result of at least one of classification between a program and a non-program, classification by type of compiler used for generating the program, classification by type of program conversion tool used for generating the program, and classification by type of function included in the program.

11. The discrimination method according to claim 7, wherein the extracting the instructions includes disassembler processing.

12. The discrimination method according to claim 7, wherein the program is malware embedded in a target file.

13. A learning apparatus comprising a processor configured to:
acquire training data including input data and output data, the input data being a plurality of input layer data strings generated by performing padding with a fixed character and encoding processing on data strings of a plurality of instructions extracted from binary data so that the data strings of the instructions each have a fixed length, the output data being a feature vector of a program including the instructions or a classification result related to the program; and
train, based on the training data, a convolutional neural network including a convolution layer so as to output the feature vector or the classification result from the input layer data strings, wherein a convolution filter size and stride in the convolution layer are determined so that processing is performed in units of the instructions.

14. The learning apparatus according to claim 13, wherein the program is malware embedded in a target file.
